(19) United States
(12) Patent Application Publication
(10) Pub. No.: US 2008/0263478 A1
(43) Pub. Date: Oct. 23, 2008

(54) System for viewing complex data

(76) Inventor: David N. Sporkin, Collin County, TX (US)

Correspondence Address: W. THOMAS TIMMONS, 1320 PRUDENTIAL DRIVE, SUITE 208, DALLAS, TX, 75235-4117, US

(21) Appl. No.: 11/888,833

(22) Filed: Aug. 2, 2007

Related U.S. Application Data
(60) Provisional application No. 60/835,835, filed on Aug. 4, 2006.

(51) Int. Cl. G06F 3/048; G06F 3/01

(52) U.S. Cl. 715/835; 707/102; 715/763; 707/E17.001

(57) ABSTRACT

The present invention comprises a computer program and system that is designed to allow a user to view complex data easily. The program is targeted at displaying information that represents the movement of information from one place, computer, data store, or account, to another. Examples of things that can be viewed include E-mails, Phone Records, Accounting Records and others. This can be used for investigation purposes, since it allows the ties between employees to be uncovered quickly. Equally important for investigations is the ability to change the focus from the owner of the mailbox to that of the correspondents. This allows the tracking of activities of the outside contact in the organization. This would also be useful for viewing ones own mailbox, when you know that you're looking for a memo that came from someone in particular, this visual representation makes it much easier to traverse emails than conventional list formats.

### CROSS-REFERENCE TO RELATED APPLICATIONS

### Statement Regarding Federally Sponsored Research or Development

Not Applicable

### INCORPORATION-BY-REFERENCE OF MATERIAL SUBMITTED ON A COMPACT DISC

Not Applicable

### BACKGROUND OF THE INVENTION

1. Field of the Invention

The present invention relates generally to data analysis and, in one of its aspects to visually organizing, displaying and reviewing collections of transactions.

2. Description of Related Art

It has been common to organize collections of transactions in lists and tree structures. Such organization sometimes appears in the form of tables.

### BRIEF SUMMARY OF THE INVENTION

The present invention comprises a computer program and system that is designed to allow a user to view complex data easily. The program is targeted at displaying information that represents the movement of information from one place, computer, data store, or account, to another. Examples of things that can be viewed include E-mails, Phone Records, Accounting Records and others. This can be used for investigation purposes, since it allows the ties between employees to be uncovered quickly. This would also be useful for viewing ones own mailbox, when you know that you're looking for a memo that came from someone in particular, this visual representation makes it much easier to find than conventional list formats.

These and other objects, advantages and features of this invention will be apparent from the following description taken with reference to the accompanying drawing, wherein is shown a preferred embodiment of the invention.

### BRIEF DESCRIPTION OF THE SEVERAL VIEWS OF THE DRAWING

FIG. 1 is a main screen view;

FIG. 2A is a filtered view of the screen of FIG. 1;

FIG. 2B is a refocus on another target of FIG. 2A;

FIG. 3 is a display message list generated from the filtered view of FIG. 2;

FIG. 4 is a display message of an email chosen from the list of FIG. 3;

FIG. 5 is a display histogram generated from the filtered list;

FIG. 6 is a display of normal traffic;

FIG. 7 is a display of traffic within a group;

FIG. 8 is an overview display;

FIG. 9 is a display of mailboxes;

FIG. 10 is a list of reports;

FIG. 11 is an overview of the system;

FIG. 12 is a diagrammatic representation of email storage organization; and

FIG. 13 is a diagram of the database of an entity relationship.

### DETAILED DESCRIPTION OF THE INVENTION

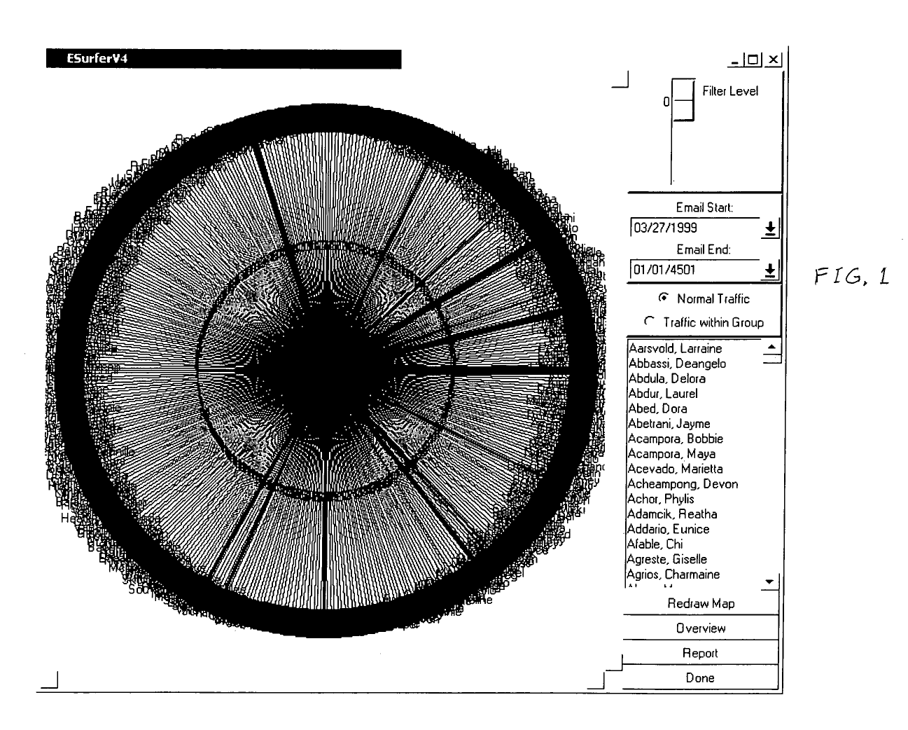

Referring now to the drawing, and in particular to FIG. 1, the source information is processed by the system, and extracted from the original storage medium, changed to the system format, and loaded into the system database. Emails and accounting records include both metadata and data, while phone logs typically only include metadata.

Once the data is loaded into the system it is viewable from the system Viewer. The viewer is re-sizable, and can be made to fit the entire screen, or any part of it. The screen has four main areas, the display area, the filter area, the grouping area, and the action area.

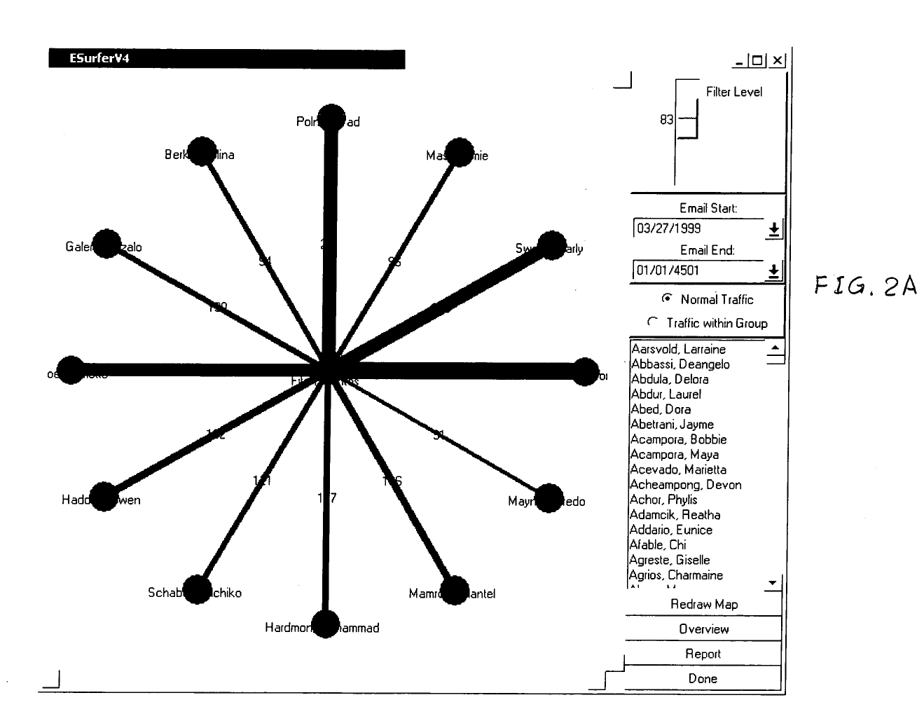

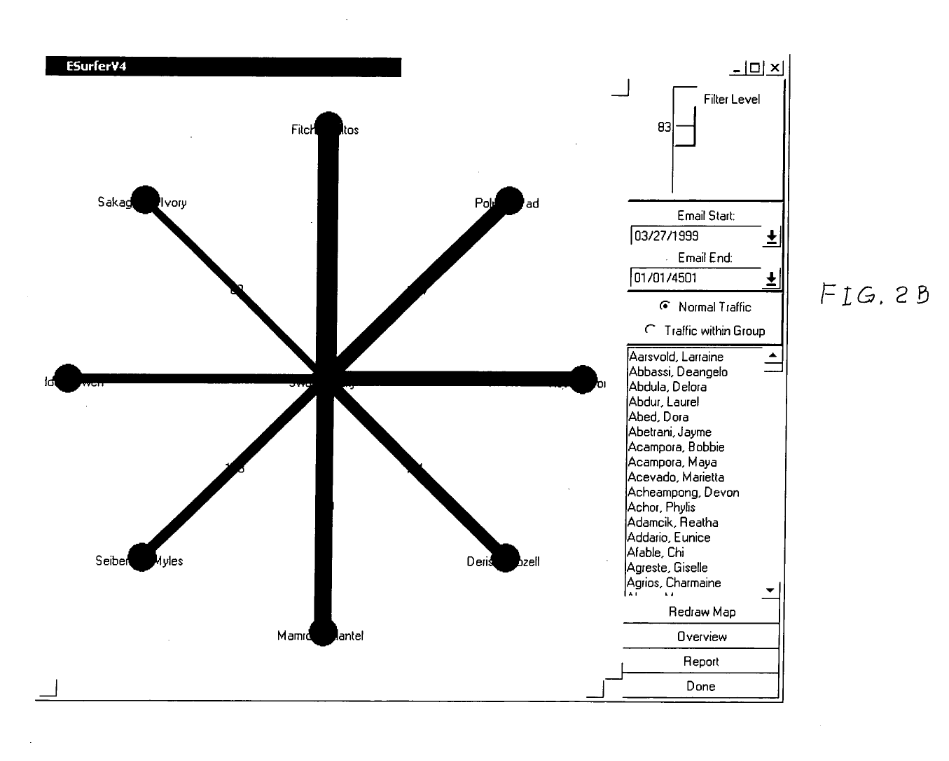

Referring also to FIG. 2, the main display area, or “wagon wheel” is shown. The red dot in the center represents the person whose data is currently being viewed. When the system first comes up, it selects the person, or account, or phone number, with the most activity and sets up the view from their perspective. Each of the lines represents traffic between the current “target”, or selected person, account, or phone number, and everyone that person corresponded with, spoke to, or transferred money to. The numbers represent an attribute of the transaction. For E-mail, the default is the number of messages, but could be the size of the messages, or the number of attachments, for example. For accounting records, it could be the number of transactions, or the total dollar amount of transactions, while for phone records, it would be the number of phone calls, or the sum of the time spent on each call. Clicking on one of the outer circles re-centers the diagram, and displays the traffic from that point of view.

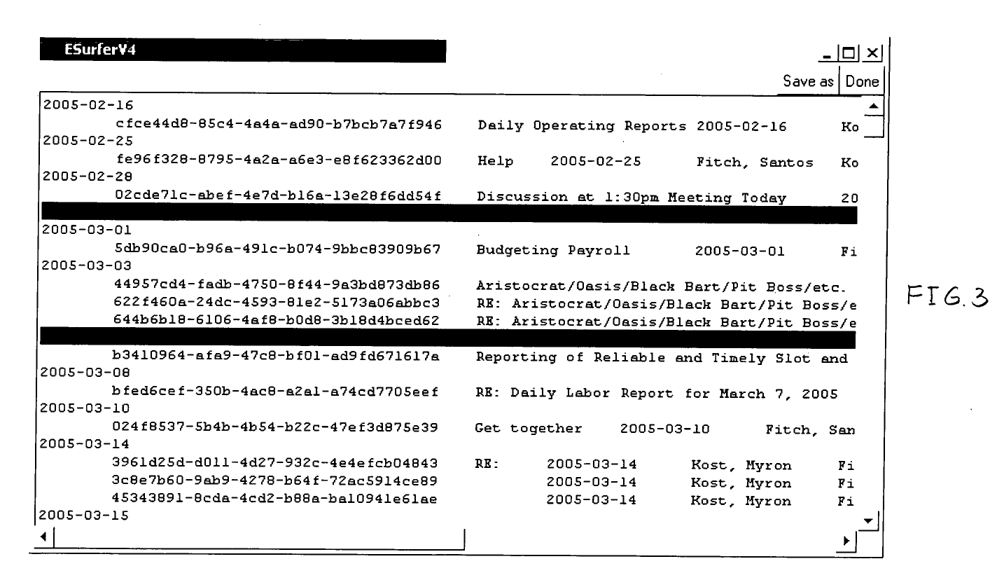

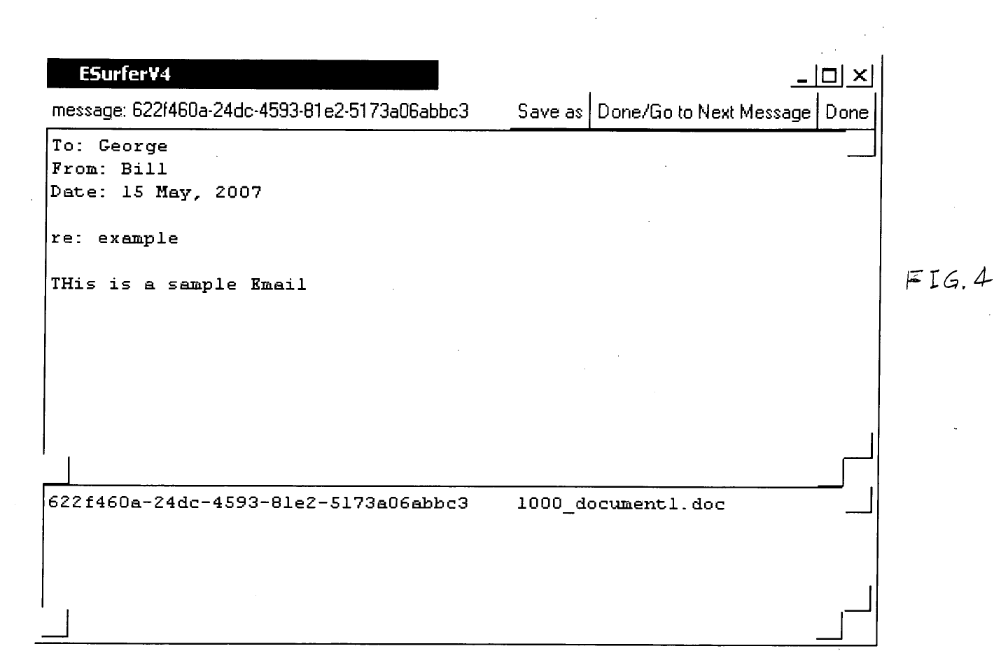

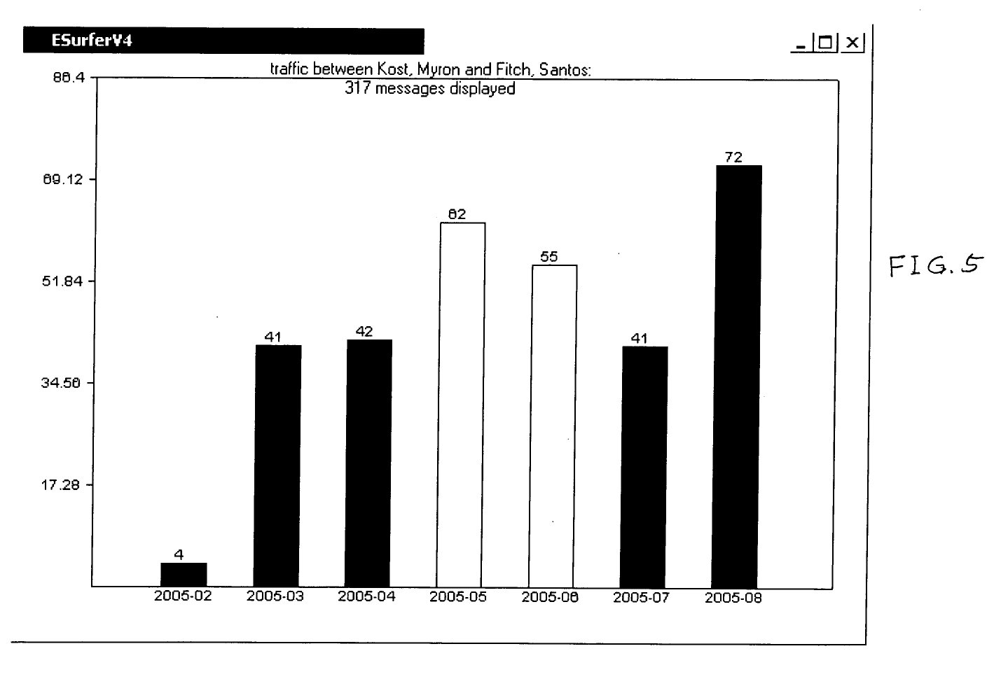

There are three actions available by clicking on one of the lines connecting the inner and outer circles. Referring also to FIG. 3, left clicking the mouse on one of the lines will display a list of the emails, transactions, or phone calls between the endpoint entities. Referring now to FIG. 4, clicking on one of the listed emails will cause it to be displayed. From the individual message display, the message can be marked on of five statuses. Referring also to FIG. 5, the will be visible to other users of the system, and will cause the item to be noted in the proper category in the report, which is shown below. Right clicking the mouse on one of the lines will display a histogram of the emails, transactions, or phone calls grouped by months. Left clicking on one of the months will display a list of the emails, transactions, or phone calls between the endpoint entities in the given month, the list shown in FIG. 3. Clicking left on the list of emails causes the email viewer to display the selected email, as in FIG. 4. (example) <control> Left clicking on the line activates the function to export records. A dialog will pop up to select a directory, and then the messages, phone records or transactions represented by the line will be copied out to the specified directory.

The filter area is in the upper right hand corner of the screen, and currently has two choices, “filter level” and Email Start/End. The filter level slider represents the minimum number of items to display. For example, moving the slider to “61” causes only line with 61 or more transactions to be displayed. This allows for easier viewing of the data, and allows the user to target those links with high levels of communications. This is shown in FIG. 2. Changing the Email start and end dates redraws the map so that only messages or transactions that occur during that time period are displayed. The date “1/1/4501” is arbitrarily assigned to emails that have been deleted and subsequently recovered by the E-mail recovery software used, so that the E-mail is valid, even if the date isn't.

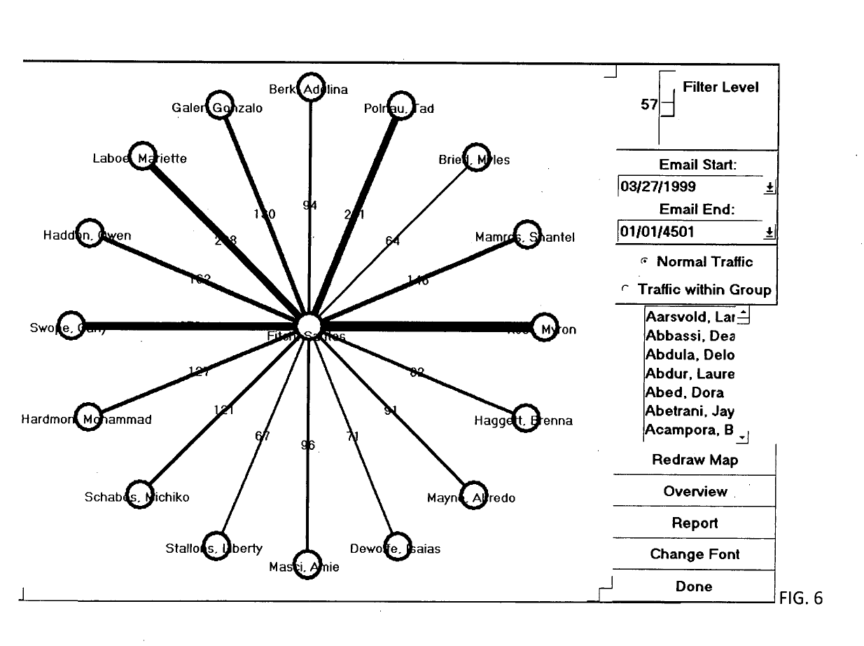

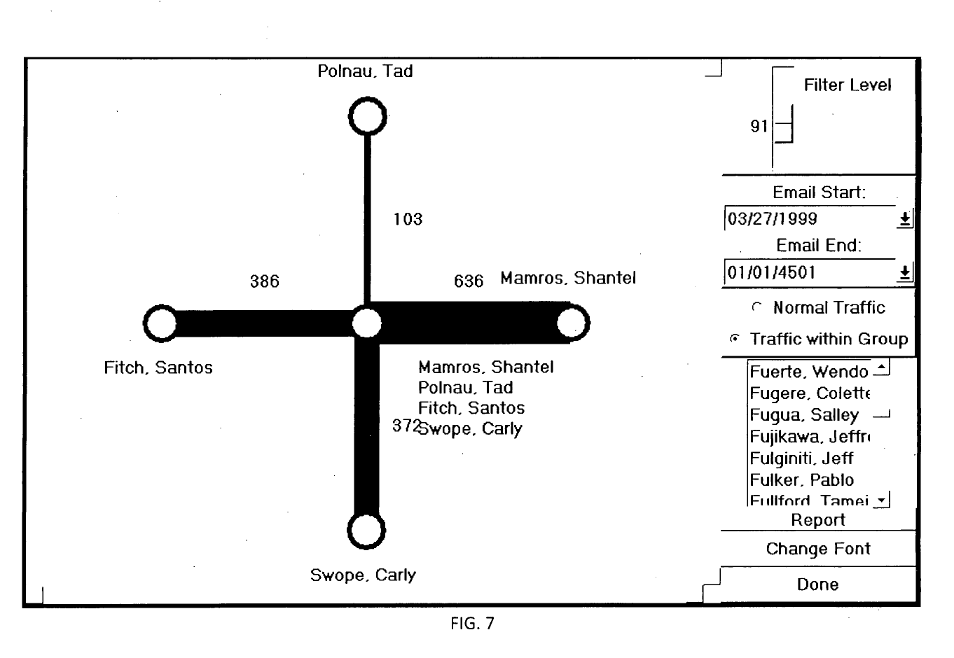

The grouping area has two options, a list of the E-mail addresses, account numbers, or phone numbers available and a grouping type checkbox. The list of names allows the user to group various E-mail addresses together. This allows two important functions. First, it allows the reviewer to put together mail that represents the same user into a single graph. For example, John A. Smith at Acme Labs may have multiple E-mail addresses like jasmith@acme.com, john.a.smith@acme.com, john.smith@acme.com, john@acme.com, jasmith1234@hotmail.com, “John A. Smith”, “John Smith”, “John”. This allows the user access to all the E-mail and connection to and from john smith, which provides a more complete view of his activities. This function can also be used to represent the activities of a group or company whose activities we would like to study. An example might be to select the addresses of the four employees associated with the purchasing function in order to determine which of them are in contact with a suspicious vendor, and quickly review the email traffic. Or we could highlight the addresses associated with the vendor, to get an idea of who they are dealing with in the company. Referring to FIG. 6, the “normal traffic” button displays information in the format previously discussed, displaying all connections from the targeted individual or group. Also referring to FIG. 7, the “group traffic” checkbox changes the display to only include email going between the selected individuals. So if we had four addresses selected, only five bubbles would be visible, one for the targets, and four destination bubbles.

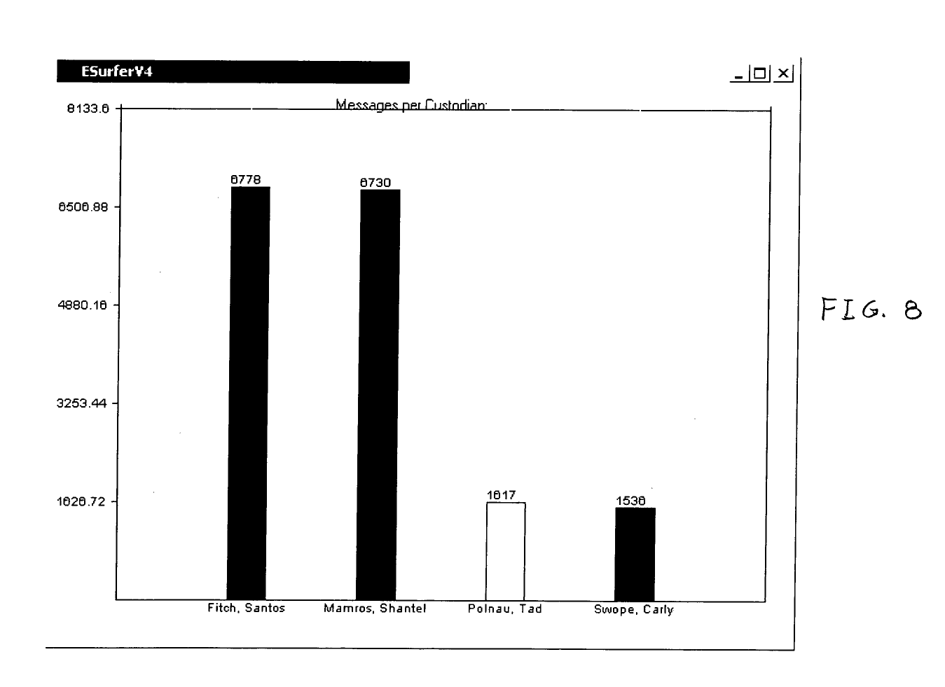

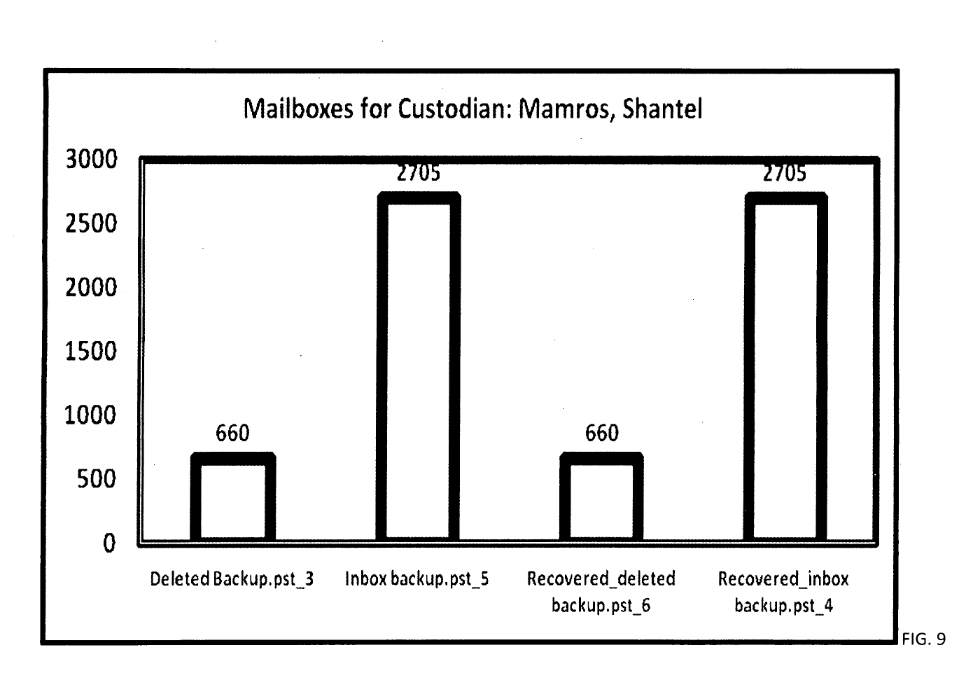

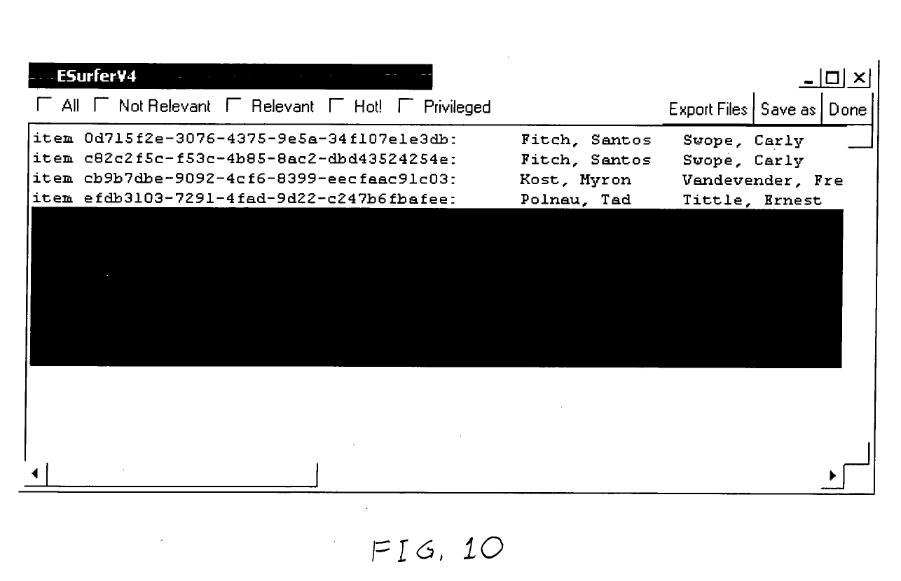

The action area contains the four buttons on the lower right hand corner of the screen. The redraw map button causes the screen to be refreshed, and is used after changes are made to the date or group selections. Referring to FIG. 8, the overview button displays a histogram of the individuals whose mailboxes was collected, and shows how many messages have been collected for each. Referring also to FIG. 9, left clicking on one of the bars displays another histogram with the mailboxes collected of that individual, and displays the number of messages associated with each. Referring to FIG. 10, the report button displays items that have been marked by the user. The default categories are “Relevant”, “Not Relevant”, “Hot” and “Privileged.” Items in a particular category can be exported by clicking the category at the top of the page, then clicking the “export files” button. The “done” button closes the application.

The system consists of four parts; the Viewer, the Metadata store, the Data store, and the Workbench. These pieces are connected by network protocols, so that they can be deployed in any configuration, such as bundled on a single computer, delivered as a client server system, or split into an n-tier system with separate display, application, database, and file servers. The system works most efficiently as a client server application, so that is the preferred configuration, but the other options are available for very large datasets.

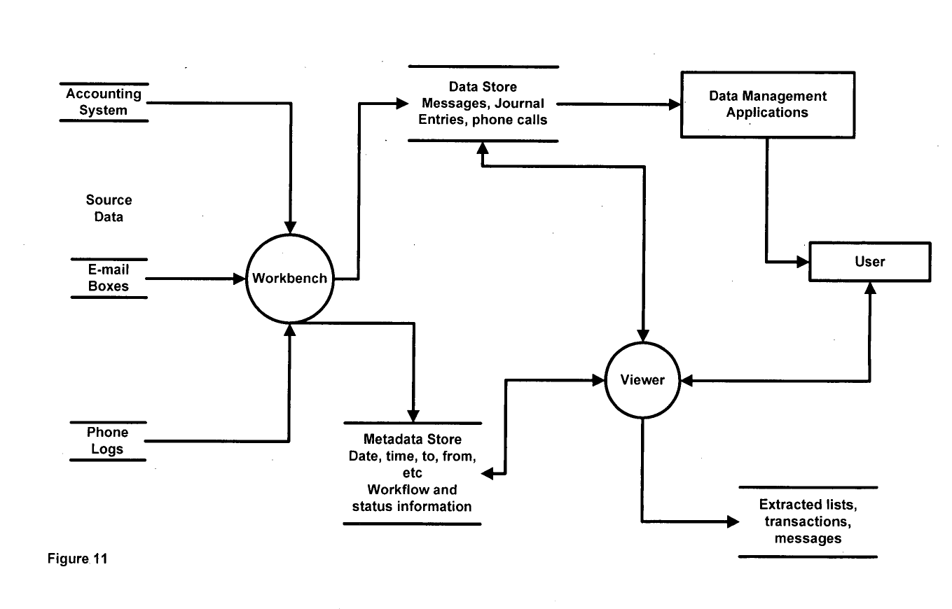

Referring now to FIG. 11, which shows an overview of the system, the Workbench is a program that translates data from its native format into the system format. It can read from various email and flat file formats. In the case of emails, the workbench program extracts the header information, the addresses referenced, the attachments, and extracts the message body and attachments to the file system, where they are stored and can be accessed by system, as well as other programs, like Windows Search. Keeping the files in this format is an advantage, because it allows users to leverage other widely available technology. In the case of transactions, the system can accept either a flat file of journal entries or a connection to the source database. At present, we copy the information into a data store in a system database. This is usually desirable when the data is being used of investigative purposes. As an enhancement, we will connect to the source system directly. This will allow real-time data to be reviewed as the transactions happen. The workbench matches transactions from the journal entries in order to set up the links. For phone logs, the system reads the log or phone bill, and gets the links directly from the log.

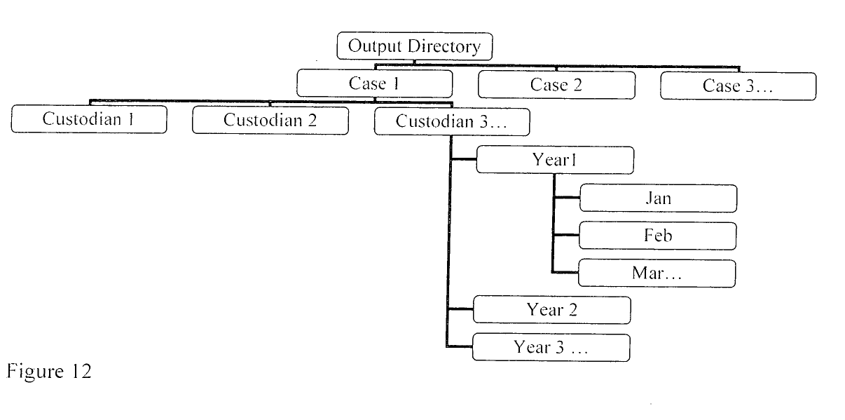

The main data store exists in two parts, a file based data store and a database based data store. The data store concept is independent of the actual storage medium, which may change as the system evolves. For example, e-mails are currently stored in the file system, with a separate file for each message and attachment. FIG. 12 shows the storage structure. Messages are extracted and stored organized by case, custodian or user, mailbox name, year, and month. As the technology matures, this information may be moved into a database, and the messages may be kept in their native format. The database based portion of the main data store consists primarily of the transactional data, such as journal entries or phone records. These are currently copied into the system data store for use by the system.

The metadata store consists of eight tables at present, which contain the information necessary to process email, transactions, and phone records. There are three tables exclusively for email, two for journal entries, and one for phone records. The source table contains summary information about what mailboxes, transactions, or phone logs were processed. These are populated by the Workbench program as data is imported into the system.

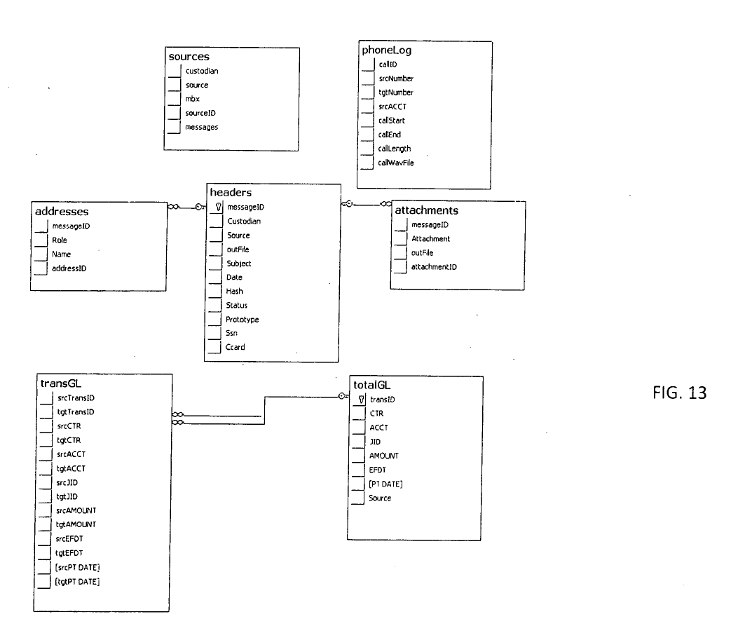

The email tables consist of a header table, an attachment table, and an address table. The header table includes an individual message id, the name of the source mailbox, the name of the extracted message, the message subject line, the date the message was sent, and the hash signature of the message. The header table also includes a status element that indicates whether the message was reviewed, and has placeholders for attributes to be assigned to the record. At present, there are flags that get set if the message contains a social security number or a credit card. FIG. 13 shows an entity relationship diagram of the database.

From the foregoing it will be seen that this invention is well adapted to attain all of the ends and objectives hereinabove set forth, together with other advantages which are inherent to the apparatus.

It will be understood that certain features and subcombinations are of utility and may be employed without reference to other features and subcombinations. This is contemplated by and is within the scope of the claims.

As many possible embodiments may be made of the invention without departing from the scope thereof, it is to be understood that all matter herein set forth or shown in the figures of the accompanying drawings is to be interpreted as illustrative and not in a limiting sense.

### SEQUENCE LISTING

Not Applicable

1. A method of visually organizing, displaying and reviewing a number of computerized transactions wherein a target is represented as a hub and sources of transaction traffic are represented as ends of spokes, which radiate from the hub.

2. A method according to claim 1, wherein the number of hits for each source of traffic with respect to the target is displayed in connection with the spoke for that source of traffic.

3. A method according to claim 2, wherein clicking a spoke drills down through the sources of traffic associated with that spoke.

4. A method according to claim 3 wherein clicking a source of traffic at the end of a spoke centers the communications data around that source of traffic, represented as a new hub.

5. A method according to claim 4, wherein the target is a first person represented as a hub and the sources of traffic are people with whom the first person had email correspondence in a given time period, the number associated with each spoke is the number of email correspondence between the first person and a second person at the end of a spoke, wherein clicking the spoke will list the email correspondence between the first person and the second person, and wherein clicking the end of the spoke will make the second person the new target of the communications data, showing with whom the second person has had email correspondence.

6. A method according to claim 4, wherein the target is a first object represented as a hub and the sources of traffic have had one or more connections with the target in a given time period, the number associated with each spoke is the number of connections between the first object and a source of traffic at the end of a spoke, wherein clicking the spoke will list the connections between the first object and the source of traffic, and wherein clicking the end of the spoke will make the source of traffic become a second object, which is a new hub, showing with new sources of traffic with which the second object has had connections.

7. A method according to claim 4, wherein the target is a first person represented as a hub and the sources of traffic are people with whom the first person had telephone conversations in a given time period, the number associated with each spoke is the number of telephone conversations between the first person and a second person at the end of a spoke, wherein clicking the spoke will list the telephone conversations between the first person and the second person, and wherein clicking the end of the spoke will make the second person a new target, the new hub person, showing with whom the second person has had telephone conversations.

8. A method according to claim 4, wherein the number of spokes and the corresponding end point sources of traffic are filtered.

9. A method according to claim 8, wherein the filter is for a property of the traffic between the target at the hub and the sources of traffic.

10. A method according to claim 8 wherein the filter is for a range of dates.

11. A method according to claim 8, wherein the filter is for the number of hits for each spoke being greater than a given number.

12. A method according to claim 8, wherein the filter if for the number of hits for each spoke being equal to a certain number.

13. A method according to claim 8, wherein the filter is for the number of hits for each spoke being less than a certain number.

14. A method according to claim 1, wherein the thickness of each spoke is representative of the amount of traffic between the target and the source of traffic associated with that spoke.

15. A method according to claim 1, wherein the length of each spoke is representative of the amount of traffic between the target and the source of traffic associated with that spoke.

16. A method according to claim 1, wherein the size of each end point is representative of the amount of traffic between the target and the source of traffic associated with that end point.

17. A method according to claim 1 wherein the target comprises a group of two or more members and the transactions are with any member of the group.

18. A method of visually organizing, displaying and reviewing a number of computerized transactions wherein a target is represented as a central point and sources of transaction traffic are represented as the remote ends of lines, which emanate from the central point.

19. A method according to claim 18, wherein the number of hits for each source of traffic is displayed in connection with the line of that source of traffic.

20. A method according to claim 19, wherein clicking a line drills down through the sources of traffic associated with that line.

21. A method according to claim 20 wherein clicking a source of traffic at the end of a line centers the search around that source of traffic, represented as a central point.

22. A method according to claim 21, wherein the number of lines and the corresponding end point sources of traffic are filtered.

23. A method according to claim 22, wherein the filter is for a property of the traffic between the target at the hub and the sources of traffic.

24. A method according to claim 18, wherein the thickness of each line is representative of the amount of traffic between the target and the source of traffic associated with that line.

25. A method according to claim 18, wherein the length of each line is representative of the amount of traffic between the target and the source of traffic associated with that line.

26. A method according to claim 18, wherein the size of each end point is representative of the amount of traffic between the target and the source of traffic associated with that end point.

27. A method according to claim 18 wherein the target comprises a group of two or more members and the transactions are with any member of the group.
